(19) United States
(12) Patent Application Publication
(10) Pub. No.: US 2016/0186696 A1
(43) Pub. Date: Jun. 30, 2016

(54) Air Guiding Arrangement Comprising Tank Ventilation System

(71) Applicant: MANN+HUMMEL GMBH, Ludwigsburg (DE)

(72) Inventors: Dietmar Talmon-Gros, Oberstenfeld (DE); Stefan Kunze, Tuebingen (DE)

(21) Appl. No.: 14/745,528

(22) Filed: Jun. 22, 2015

(30) Foreign Application Priority Data
Dec. 25, 2014 (DE) 10 2014 009 213.5

(51) Int. Cl. F02M 25/08; F02M 35/104; F02M 35/10

(52) U.S. Cl. CPC F02M 25/0836; F02M 25/0854; F02M 25/0872; F02M 35/10157; F02M 35/10222; F02M 35/10268; F02M 35/104

(57) ABSTRACT

An air guiding arrangement for an internal combustion engine is provided with an intake manifold that supplies intake air to the internal combustion engine, wherein the intake manifold has a flow compressor apparatus with a compressor. A tank ventilation system for a fuel tank of the internal combustion engine is provided, wherein the tank ventilation system has an adsorption filter and a first ventilation line which is branching off the adsorption filter. A throttle device is provided upstream of the compressor in the intake manifold. The ventilation line is connected to the intake manifold and opens into the intake manifold at a location between the throttle device and the compressor.

### BACKGROUND OF THE INVENTION

The invention concerns an air guiding arrangement for an internal combustion engine, wherein the air guiding arrangement comprises an intake manifold by means of which intake air can be supplied to the internal combustion engine and which comprises a compressor of a flow compressor apparatus. The air guiding system further comprises a tank ventilation system for a fuel tank of the internal combustion engine, wherein the tank ventilation system comprises an adsorption filter and a ventilation line which is branching off the adsorption filter.

DE 10 2009 008 831 A1 discloses a charged internal combustion engine that is provided with a tank ventilation system by means of which hydrocarbons evaporating from a fuel tank are collected in an adsorption filter so that only unladen air can escape into the atmosphere. The adsorption filter is embodied as a fuel vapor storage container filled with activated carbon which is in flow communication with the fuel tank. The activated carbon must be regenerated regularly which is done by means of a ventilation line through which the storage container filled with the activated carbon is connected to the intake manifold. The ventilation line comprises two inlet locations into the ventilation tract, i.e., on the one hand, upstream of a compressor in the intake manifold and, on the other hand, downstream of an adjustable throttle valve which is downstream of the compressor within the intake manifold.

### SUMMARY OF THE INVENTION

It is the object of the invention to enable regeneration of an adsorption filter, which is part of a tank ventilation system for an internal combustion engine, with simple constructive measures in a reliable and satisfactory way.

This object is solved according to the invention in that a throttle device upstream of the compressor is provided within the intake manifold and in that the ventilation line opens into the intake manifold between the throttle device and the compressor. The dependent claims provide expedient further developments.

The air guiding arrangement for a chargeable internal combustion engine comprises a flow compressor apparatus, for example, an exhaust gas turbocharger, which comprises a drive unit, for example, an exhaust gas turbine in the exhaust gas tract, and a compressor in the intake manifold of the internal combustion engine. The fuel tank which is associated with the internal combustion engine is provided with a tank ventilation system which comprises an adsorption filter for adsorption of escaping hydrocarbons (HO) as well as a ventilation line which is branching off the adsorption filter and by means of which purification and regeneration of the adsorption filter is realized. In this context, the hydrocarbons which are adsorbed in the absorption filter are discharged so that the hydrocarbon filling level of the adsorption filter is reduced again and the adsorption filter is again capable of adsorbing hydrocarbons to a satisfactory degree after regeneration.

The ventilation line opens into the intake manifold so that the hydrocarbons of the adsorption filter are supplied to the internal combustion engine. The connecting location of the ventilation line in the intake manifold is located between a throttle device, which is arranged in the intake manifold upstream of the compressor, and the compressor of the flow compressor apparatus or the exhaust gas turbocharger.

This has the advantage that, on the one hand, the pressure drop which is generated across the throttle device causes a pressure differential between the adsorption filter and the opening location of the ventilation line so that flushing and regenerating of the adsorption filter is possible within wide operating ranges of the internal combustion engine. On the other hand, at the connecting location of the ventilation line into the intake manifold, an intake pressure is acting which is generated by the compressor and which also contributes to a pressure gradient between the adsorption filter and the connecting location of the ventilation line at the intake manifold. Thus, two effects are combined which each contribute to a pressure gradient so that flushing and regenerating of the absorption filter can be performed to a satisfactory degree and without additional measures.

According to an expedient embodiment, the throttle device is embodied to be adjustable so that the air flow through the intake manifold can be affected in a changeable way by the throttle device. The throttle device can be, for example, a throttle valve by means of which the air flow can be reduced or, according to a further expedient embodiment, it can be a swirl generator which also affects the air flow in the intake manifold and imparts a swirling action so that the air is supplied to the compressor with a swirl. The swirl generator is preferably designed to be changeably adjustable and enables a changeable air flow in the intake manifold. In principle, swirl generators without adjusting possibilities are conceivable also.

Expediently, a check valve is integrated into the ventilation line which blocks flow in the direction toward the adsorption filter and only opens in the opposite direction, i.e., from the adsorption filter in the direction toward the intake manifold. By means of the check valve, it is ensured that in those phases in which no pressure gradient is existing between adsorption filter and inflow opening into the intake manifold, no unwanted return flow through the ventilation line in the direction toward the adsorption filter takes place. The check valve thus permits only flow from the adsorption filter to the intake manifold.

It may be expedient to arrange within the ventilation line an adjustable control valve by means of which the flow through the ventilation line is adjustable. The control valve can replace optionally the check valve, wherein also a combination of check valve and control valve is conceivable. In the latter case, the control valve is, for example, located upstream of the check valve, wherein also an arrangement downstream of the check valve is conceivable. The check valve is adjusted as a function of the actual operating state of the internal combustion engine, in particular as a function of the pressure which is currently existing at the connecting location of the ventilation line into the intake manifold. Inasmuch as in the ventilation line the check valve is eliminated and only a control valve is provided, the latter, in case the pressure differential is insufficient for flushing the adsorption filter, is moved into the closed position in order to prevent undesirable return flow.

According to a further expedient embodiment, the adsorption filter is designed as an activated carbon filter. Conceivable are, for example, embodiments in which the adsorption filter comprises a container which is filled with activated carbon through which the hydrocarbons which are escaping from the fuel tank are passed.

### BRIEF DESCRIPTION OF THE DRAWINGS

Further advantages and expedient embodiments can be taken from the additional claims, the figure description, and the drawings.

FIG. 1 shows in schematic illustration a charged internal combustion engine, wherein a swirl generator is provided upstream of the compressor in the intake manifold and a tank ventilation system is provided which comprises an adsorption filter and a ventilation line that opens between the swirl generator and the compressor into the intake manifold.

FIG. 2 shows a similar embodiment as in FIG. 1, however with an embodiment variant of the swirl generator.

In the figures, same components are provided with same reference characters.

### DESCRIPTION OF PREFERRED EMBODIMENTS

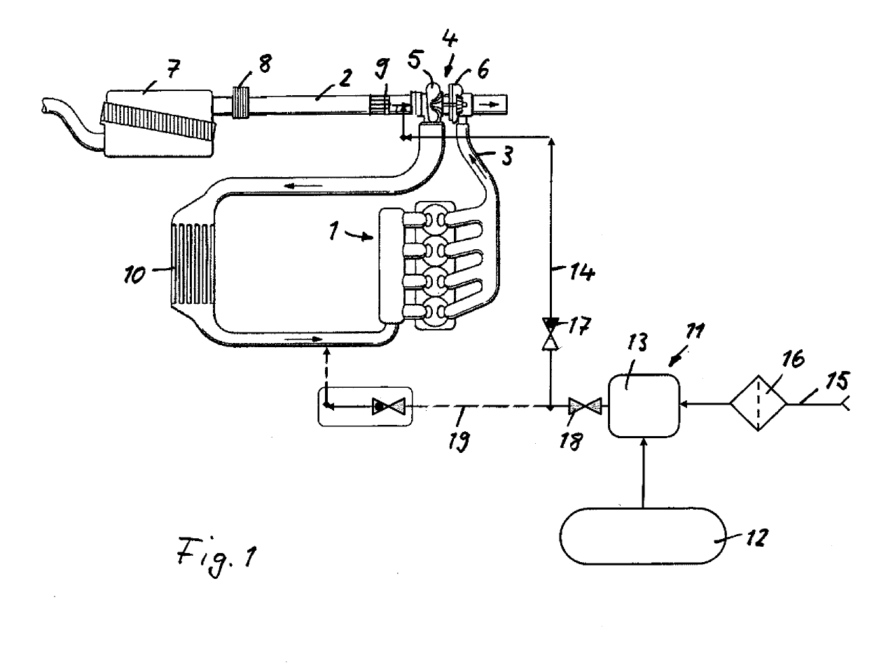

In FIG. 1, an internal combustion engine 1 comprising an air guiding arrangement is illustrated, wherein combustion air is supplied to the internal combustion engine 1 by means of an intake manifold 2 of the air guiding arrangement. The exhaust gases emitted by the internal combustion engine 1 are discharged via an exhaust gas tract 3.

The air guiding arrangement of the internal combustion engine 1 is provided with a flow compressor apparatus in the form of an exhaust gas turbocharger 4 which comprises a compressor 5 in the intake manifold 2 and an exhaust gas turbine 6 in the exhaust gas tract 3. The exhaust gas turbine 6 is driven by the pressurized exhaust gases and drives, in turn, the compressor 5 which compresses sucked-in combustion air to an increased charge pressure at which the combustion air is supplied to the cylinders of the internal combustion engine 1.

The combustion air which is introduced into the intake manifold 2 is subjected first to filtration in an air filter 7. Downstream of the air filter 7, a mass air flow meter 8 is provided in the intake manifold 2. A swirl generator 9 is arranged in the further course in the intake manifold. It is located upstream of the compressor 5 of the exhaust gas turbocharger 4 and imparts a swirl to the supplied combustion air with which the air is flowing into the compressor 5. After compression in the compressor 5, the combustion air is cooled during the further course within a charge air cooler 10 and subsequently supplied to the cylinders of the internal combustion engine 1.

The internal combustion engine 1 is provided with a tank ventilation system 11 which serves to collect hydrocarbons (HO) escaping from the fuel tank 12 and to prevent escape of the hydrocarbons into the environment. The tank ventilation system 11 comprises an adsorption filter 13 which comprises a container with activated carbon as well as a ventilation line 14 with which the adsorption filter 13 is connected to the intake manifold 2. The adsorption filter 13 is in flow communication with the fuel tank 12 so that hydrocarbons which are rising from the fuel tank 12 reach the adsorption filter 13 and are retained and stored in the activated carbon of the adsorption filter.

For regenerating the adsorption filter 13, the latter must be flushed and the flushing process causes the adsorbed hydrocarbons to be washed out of the activated carbon in the adsorption filter. This is done by generating an air flow which is passed through the adsorption filter 13. For this purpose, the adsorption filter 13 is supplied with fresh air by means of a supply line 15 in which a filter element 16 is arranged. At the raw side the adsorption filter 13 is connected with the ventilation line 14 which opens into the intake manifold 2.

For flushing the adsorption filter 13, a pressure gradient must be generated across the adsorption filter. This is achieved in that the ventilation line 14 opens into the intake manifold 2 between the swirl generator 9 and the compressor 5. By means of the swirl generator 9, a pressure gradient is produced in the intake manifold 2 and, furthermore, the compressor 5 sucks in air so that the flow area of the intake manifold 2 located between swirl generator 9 and compressor 52 is subjected to two pressure-reducing effects that act by means of the connecting location also onto the ventilation line 14. In this way, it is ensured that within a wide operating range of the internal combustion engine pressure conditions are existing which enable flushing and regenerating of the adsorption filter 13.

A check valve 17 is integrated into the ventilation line 14 that blocks flow in the direction toward the adsorption filter 13. The check valve 17 ensures that flow is possible only from the adsorption filter in the direction toward the intake manifold 2, but flow is interrupted or blocked in the opposite direction.

In addition, an adjustable control valve 18 is integrated into the ventilation line 14 in the shown embodiment and is arranged between the adsorption filter 13 and the check valve 17. The control valve 18 can be adjusted as a function of the actual state parameters or operating parameters of the internal combustion engine or of devices associated with the internal combustion engine, in particular as a function of the pressure that is currently existing in the intake manifold. Optionally, the check valve 17 may be omitted and a return flow from the intake manifold into the absorption filter 13 can be prevented simply by moving the control valve 18 into the closing position, in case there is no pressure gradient between adsorption filter 13 and opening of the ventilation line 14 into the intake manifold 2.

The dash-dotted line indicates a second ventilation line 19 which is branching off the first ventilation line 14 and opens into the intake manifold 2 downstream of the charge air cooler 10. The second ventilation line 19 is optional, i.e., the second ventilation line 19 can be omitted. In the second ventilation line 19, there is also a check valve which is blocking flow in the direction toward the adsorption filter 13.

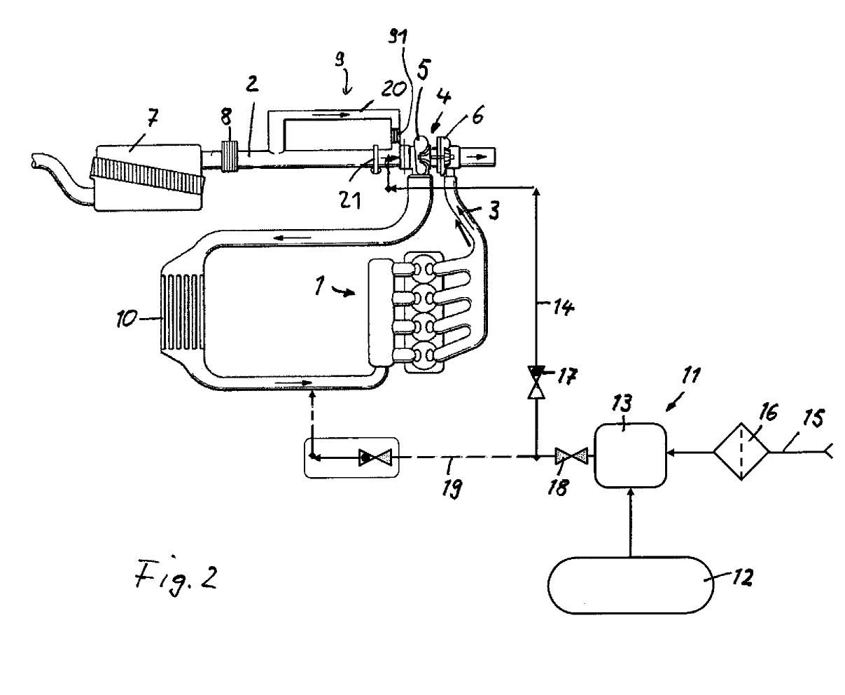

The embodiment according to FIG. 2 is substantially of the same configuration as that of FIG. 1 so that reference can be had to the above description of the embodiment of FIG. 1. In contrast to FIG. 1, a swirl passage 20 is arranged so as to extend parallel to the intake manifold 2; it is part of the swirl generator 9 and branches off the intake manifold 2 upstream of the control member 91 of the swirl generator 9 and reconnects with the intake manifold 2 in the area between the control member 91 of the swirl generator 9 and compressor 5. A portion of the sucked-in air stream is guided through the swirl channel 20 and, imparted with a swirl, is supplied to the compressor 5. The connecting location of the ventilation line 14 of the tank ventilation system 11 opens into the section of the intake manifold 2 between the control member 91 of the swirl generator 9 and the compressor 5. The intake manifold 2 comprises a switching flap 21.

While specific embodiments of the invention have been shown and described in detail to illustrate the inventive principles, it will be understood that the invention may be embodied otherwise without departing from such principles.

What is claimed is:

1. An air guiding arrangement for an internal combustion engine, the air guiding arrangement comprising:
an intake manifold configured to supply intake air to the internal combustion engine, wherein the intake manifold comprises a flow compressor apparatus with a compressor;
a tank ventilation system for a fuel tank of the internal combustion engine, wherein the tank ventilation system comprises an adsorption filter and a first ventilation line which is branching off the adsorption filter;
wherein the intake manifold comprises a throttle device provided upstream of the compressor;
wherein the ventilation line is connected to the intake manifold and opens into the intake manifold at a location between the throttle device and the compressor.

2. The air guiding arrangement according to claim 1, wherein the throttle device is a swirl generator configured to generate a swirl in an air stream supplied to the compressor.

3. The air guiding arrangement according to claim 1, wherein the throttle device is configured to be adjustable.

4. The air guiding arrangement according to claim 1, wherein the first ventilation line comprises a check valve blocking the first ventilation line in a direction toward the adsorption filter.

5. The air guiding arrangement according to claim 1, wherein the adsorption filter is an activated carbon filter.

6. The air guiding arrangement according to claim 1, wherein the first ventilation line comprises an adjustable control valve.

7. The air guiding arrangement according to claim 1, further comprising a second ventilation line connecting the adsorption filter to the intake manifold.

8. The air guiding arrangement according to claim 7, wherein the second ventilation line opens downstream of the first ventilation line into the intake manifold.

9. The air guiding arrangement according to claim 7, wherein the intake manifold comprises a charge air cooler, wherein the second ventilation line opens downstream of the charge air cooler into the intake manifold.

10. An internal combustion engine comprising an air guiding arrangement according to claim 1.
